(19) United States
(12) Patent Application Publication
(10) Pub. No.: US 2007/0115082 A1
(43) Pub. Date: May 24, 2007

(54) MEMS Switch Contact System

(75) Inventors: Mark Schirmer, Stoughton, MA (US); John Dixon, Van Nuys, CA (US)

Correspondence Address: BROMBERG & SUNSTEIN LLP, 125 SUMMER STREET, BOSTON, MA, 02110-1618, US

(73) Assignee: ANALOG DEVICES, INC., Norwood, MA (US)

(21) Appl. No.: 11/538,251

(22) Filed: Oct. 3, 2006

Related U.S. Application Data
(60) Provisional application No. 60/723,019, filed on Oct. 3, 2005.

(51) Int. Cl. H01H 51/22

(52) U.S. Cl. 335/78

(57) ABSTRACT

A MEMS switch has 1) a first contact, and 2) a second contact that is movable relative to the first contact. At least one of the contacts is electrically conductive and has a platinum-series based material.

### PRIORITY

This patent application claims priority from provisional U.S. patent application No. 60/723,019, filed Oct. 3, 2005 entitled, “MEMS CONTACT SYSTEM USING Pt SERIES METALS AND SURFACE PREPARATION THEREOF,” and naming Mark Schirmer as the sole inventor, the disclosure of which is incorporated herein, in its entirety, by reference.

### FIELD OF THE INVENTION

The invention generally relates to MEMS switches and, more particularly, the invention relates to contact systems for MEMS switches.

### BACKGROUND OF THE INVENTION

A wide variety of electrical switches operate by moving one member into direct contact with another member. For example, a relay switch may have a conductive cantilever arm that, when actuated, moves to directly contact a stationary conductive element. This direct contact closes an electrical circuit, consequently electrically communicating the arm with the stationary element to complete an ohmic connection. Accordingly, the physical portions of the arm that directly contact each other are known in the art as “ohmic contacts,” or as referred to herein, simply “contacts.”

Contacts often are fabricated by forming an electrically conductive metal on another surface, which may or may not be an insulator. For example, a cantilevered arm may be formed from silicon, while the contact at its end is formed from a conductive metal. When exposed to oxygen, water vapor, and environmental contaminants, however, the metal may react to form an insulative surface contamination layer, such as an insulative nitride layer, insulative organic layer, and/or an insulative oxide layer. As a result, the contact may be less conductive. Larger switches nevertheless generally are not significantly affected by this phenomenon because they often are actuated with a force sufficient to “break or scrub through” the surface contamination layer (e.g., an insulative oxide layer).

Conversely, switches with much smaller actuation, forces often are not able to break through this surface contamination layer. For example, electrostatically actuated MEMS switches often have typical contact forces measured in Micronewtons, which can be on the order of 1000 to 10,000 times less than the comparable force used in larger switches, such as reed or electromagnetic relays. Accordingly, the insulative surface contamination layer may degrade conductivity, which, in addition to reducing its effectiveness, reduces the lifetime of the switch.

### SUMMARY OF THE INVENTION

In accordance with one embodiment of the invention, a MEMS switch has 1) a first contact, and 2) a second contact that is movable relative to the first contact. At least one of the contacts is electrically conductive and has a platinum-series based material.

The platinum-series based material may include a platinum-series element. Alternatively, the platinum-series based material may be a platinum-series based oxide. In some embodiments, at least one of the contacts has both a platinum-series based element and a conductive passivation. For example, the platinum-series based element may be ruthenium, while the conductive passivation may be ruthenium dioxide.

The apparatus also may have a package containing at least a portion of the MEMS switch. To mitigate the adverse effect of contaminants, such as free oxygen, within its interior, the package may have a contaminant gettering site. For example, the package may be a wafer level package having a cap with an interior surface supporting an exposed platinum-series element. In some embodiments, the package hermetically seals the first and second contacts.

In accordance with another embodiment of the invention, a MEMS apparatus has a substrate, a first contact, and a movable member with a second contact that moves relative to the substrate. The substrate supports the movable member. Moreover, at least one of the contacts has a conductive platinum-series based material that provides an electrical connection when contacting the other electrical contact.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows an electronic system a switch that may be configured in accordance with illustrative embodiments of the invention.

FIG. 2A schematically shows a cross-sectional view of a MEMS switch configured in accordance with one embodiment of the invention.

FIG. 2B schematically shows a cross-sectional view of a MEMS switch configured in accordance with another embodiment of the invention.

FIG. 3A schematically shows a cross-sectional view of a MEMS switch configured in accordance with yet another embodiment of this invention.

FIG 3B schematically shows a cross-sectional view of the MEMS switch of FIG. 3A in an actuated position.

FIG. 4 shows a process of forming a MEMS switch in accordance with illustrative embodiments of the invention.

### DESCRIPTION OF ILLUSTRATIVE EMBODIMENTS

In illustrative embodiments, a MEMS switch has a contact formed from a platinum-series based material. For example, the contact may be formed from ruthenium metal (hereinafter “ruthenium” alone), ruthenium dioxide, or both. This type of contact should have material properties that provide favorable resistances and durability, while at the same time minimizing undesirable insulative surface contamination layers that could degrade switch performance. Details of illustrative embodiments are discussed below.

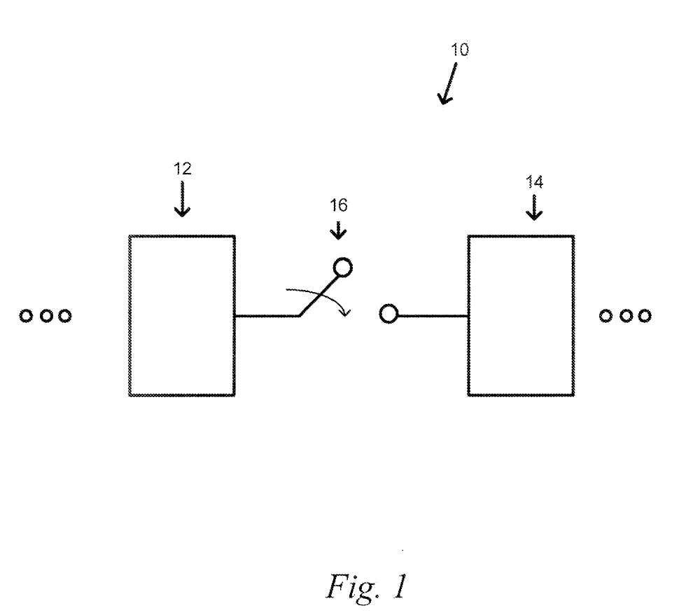

FIG. 1 schematically shows an electronic system 10 using a switch that may be implemented in accordance with illustrative embodiments of the invention. In short, the electronic system 10 has a first set of components 12 represented by a block of the left side of the figure, the second set of components 14 represented by a block on the right side of the figure, and a switch 16 that alternatively connects the first and second sets of components 12 and 14. In illustrative embodiments, the switch 16 is a microelectromechanical system, often referred to in the art as a “MEMS device.” Among other things, the system 10 shown in FIG. 1 may be a part of a RF switching system within a cellular telephone.

As known by those skilled in the art, when closed, the switch 16 electrically connects the first set of components 12 with the second set of components 14. Accordingly, when in this state, the system 10 may transmit electronic signals between the first and second sets of components 12 and 14. Conversely, when the switch 16 is opened, the two sets of components 12 and 14 are not electrically connected and thus, cannot electrically communicate through this path.

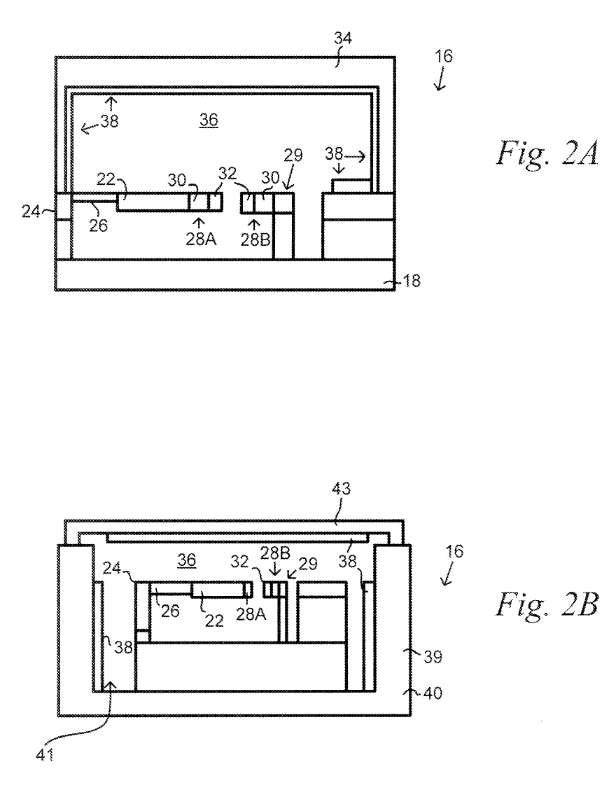

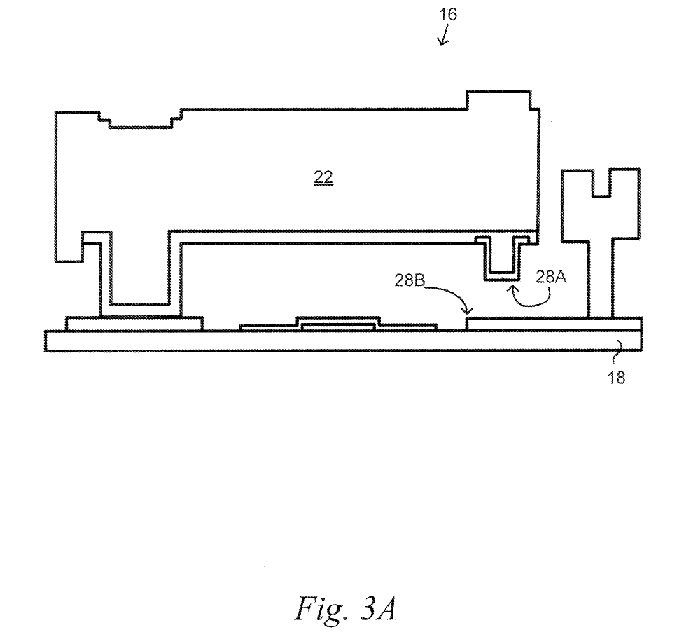

FIG. 2A schematically shows a cross-sectional view of a MEMS switch 16 configured in accordance with illustrative embodiments of the invention. In this embodiment, the MEMS switch 16 is formed as an integrated circuit packaged at the wafer level. Specifically, the switch 16 has a substrate 18 supporting and suspending movable structure that alternatively opens and closes a circuit. To that end, the movable structure includes a movable member 22 movably connected to a stationary member 24 by means of a flexible spring 26.

The stationary member 24 illustratively is fixedly secured to the substrate 18 and, in some embodiments, serves as an actuation electrode to move the movable member 22, when necessary. Alternatively, or in addition, the switch 16 may have one or more other actuation electrodes not shown in the figures. It should be noted, however, that electrostatically actuated switches are but one embodiment. Various embodiments apply to switches using other actuation means, such as thermal actuators and electromagnetic actuators. Discussion of electrostatic actuation therefore is not intended to limit all embodiments.

The movable member 22 has an electrical contact 28A at its free end for alternately connecting with a corresponding contact 28B on a stationary contact beam 29. When actuated, the movable member 22 translates in a direction generally parallel to the substrate 18 to contact the contact 28B on the stationary contact beam 29. During use, the movable member 22 alternatively opens and closes its electrical connection with the stationary contact beam 29. When closed, the switch 16 creates a closed circuit that typically forms a communication path between various elements, such as those discussed above.

The die forming the electronic switch 16 can have a number of other components. For example, the die could also have circuitry (not shown) that controls a number of functions, such as actuation of the movable member 22. Accordingly, discussion of the switch 16 without circuitry is for convenience only.

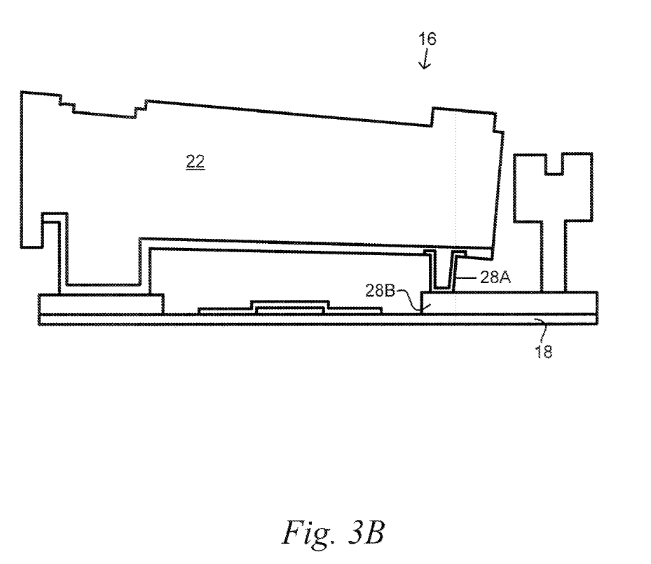

It should be noted that various embodiments can use a wide variety of different types of switches. For example, the switch 16 could multiplex more than two nodes and thus, be a three or greater position switch. Those skilled in the art should be capable of applying principles of illustrative embodiments to a wide variety of different switches. Discussion of the specific switch 16 in FIGS. 2A and 2B, as well as the switch 16 in FIGS. 3A and 3B, thus are illustrative and not intended to limit a number of different embodiments.

In accordance illustrative embodiments of the invention, one or both of the two noted contacts 28A and/or 28B is formed from a platinum-series based material (also known as “platinum group” or “platinum metals”). Specifically, as known by those skilled in the art, platinum-series elements include platinum (Pt), ruthenium (Ru), rhodium (Rh), palladium (Pd), osmium (Os), and iridium (Ir). Contacts 28A or 28B having platinum-series based materials therefore comprise a least a platinum-series based element. For example, ruthenium dioxide (RuO₂) is considered to be a platinum-series based material because part of it is ruthenium.

In one embodiment, one contact (e.g., contact 28A) is formed from a platinum-series based material, while the other contact (e.g. contact 28B) is formed from another type of material, such as a gold based material. In preferred embodiments, however, both contacts 28A and 28B are formed from a platinum-series based material. In some embodiments, this material simply may be a conductive oxide, such as ruthenium dioxide. In other embodiments, however, one or both of the contacts 28A and 28B have at least two layers; namely, a base layer 30 and a conductive passivation layer 32 (also referred to simply as “passivation layer 32” or more generally as “conductive passivation”). For example, the base layer 30 may be a platinum-series element, such as ruthenium, while the passivation layer 32 is a conductive oxide. Among others, the conductive oxide may be a platinum-series based material, such as ruthenium dioxide. In other embodiments using this two layer approach, however, the conductive oxide is not a platinum-series based material. Moreover, this two layer approach can have additional layers, such as an adhesion layer between the two layers 30 and 32.

Platinum-series based elements provide a number of advantages when used to form contacts 28A and/or 28B. Specifically, in the MEMS context, thin layers of such materials (e.g., on the order of angstroms) provided a relatively low resistivity while being hard enough to withstand repeated contact. During experiments, however, contacts formed from platinum-series elements alone undesirably formed an insulative surface contamination layer. It subsequently was discovered that application of an appropriate conductive oxide both passivated the base layer 30 and substantially mitigated formation of an insulative surface contamination layer. Moreover, the conductive oxide permitted sufficient conductivity. It also was discovered that rather than using a two layer approach, a single conductive oxide comprised of a platinum-series based material also provided satisfactory results. Consequently, when applied as discussed herein, certain materials, such as platinum-series based materials, can be used to form the contacts 28A and/or 28B without the significant risk of formation of an insulative surface contamination layer.

As noted above, the switch 16 in FIG. 2A is packaged at the wafer level. To that end, the switch 16 also has a cap 34 for protecting the sensitive internal microstructure. In illustrative embodiments, the cap 34 forms a hermetically sealed chamber 36 that protects the internal components of the switch 16.

It is anticipated that the conductive passivation layer 32 may deteriorate or degrade to some extent during the lifetime of the switch 16, or have some kind of imperfection that adversely affects its passivation capabilities. For example, although it serves its purpose as a satisfactory passivation element, the discussed conductive oxide still may have some permeability to oxygen remaining in the chamber 36 from fabrication processes. Specifically, semiconductor packaging processes often seal the chamber 36 in the presence of oxygen. In one such process, glass frit wafer-to-wafer bonding processes may require bonding in the presence of oxygen to facilitate organic burn off of volatile solvents in the glass paste. In addition, if the glass contains lead, oxygen may be required to oxidize any metallic lead to prevent subsequent surface contamination.

As noted above, exposure to these contaminants can cause formation of an insulative surface contamination layer. For example, when at least one of the contacts 28A or 28B is formed from ruthenium, sufficient exposure to oxygen may cause formation of an insulative oxide layer, such as a ruthenium oxide (RuO) layer, or a ruthenium tetraoxide (RuO₄) layer.

Accordingly, to further protect the contacts 28A and 28B, illustrative embodiments provide a gettering system 38 for attracting and trapping much of the residual contaminants, such as oxygen, if any, within the hermetically sealed chamber 36. For example, among other ways of gettering, the switch 16 may have a coating of deposited platinum-series metal, such as ruthenium, innocuously located within the chamber 36. To that end, FIG. 24A shows ruthenium coated on portions of the interior facing surface of the cap 34, and on innocuous, inactive, “white” areas of the die surface. To provide maximum efficiency, the exposed gettering material preferably has a surface area that is substantially greater than the surface area of the contacts 28A and 28B. For example, the contacts 28A and 28B may have a total area of 3-12 microns squared, while the area of the gettering material could have an area of 500-1000 microns squared. Although not optimal, some embodiments do not passivate the contact 28A and/or 28B (e.g., with a conductive oxide if the contact 28A and/or 28B is a metal, such as ruthenium) and simply use the gettering system 38. It should be noted that the gettering system 38 can be formed to attract contaminants other than oxygen. Accordingly, discussion of an oxygen gettering system is illustrative.

FIG. 2B schematically shows a cross-sectional view of another embodiment of the invention. One primary difference between this embodiment and the switch 16 shown in FIG. 2A is its packaging design. Specifically, unlike the switch 16 shown in FIG. 2A, the switch 16 in this embodiment is packaged in a conventional cavity package 38 that contains the entire switch die. To that end, the package has a base 39 forming a cavity 41, and a lid 43 that hermetically seals the cavity 41 to form the package chamber 36 noted above. As an example, the cavity package 38 could be a conventional ceramic cavity package commonly used in the semiconductor industry. In a manner similar to the switch 16 shown in FIG. 2A, this switch 16 also has a gettering system 38 within its interior. To that end, the chamber 36 may have several gettering sites, such as on the interior facing surface of the lid 43, along the sidewalls of the base 39, and on the die itself. Of course, the gettering sites could be in other locations within the interior chamber 36. Accordingly, discussion of specific locations of the gettering sites is illustrative and not intended to limit various embodiments of the invention.

The switch 16 can be packaged in a number of other types of packages. Discussion of the two types in FIGS. 2A and 2B therefore is illustrative only.

Another difference between the switch 16 in FIG. 2A and this switch 16 is the makeup of one of its contact 28A. Specifically, the contact 28A on the movable member 22 is the single layer type discussed above (i.e., no passivation layer 32). For example, this single layer contact 28A may be formed from a platinum-series based conductive oxide, such as ruthenium dioxide.

Of course, as noted above, various embodiments apply to many different types of switches. For example, rather than apply to switches having one stationary contact 28B and another moving contact 28A, various embodiments apply to switches having two or more moving contacts. FIGS. 3A and 3B show yet another example of a switch 16 that may implement illustrative embodiments in the invention. FIG. 3A shows the switch 16 in an open circuit position (i.e., not actuated), while FIG. 3B shows the same switch 16 in a closed position (i.e., in an actuated position, which closes the circuit). For simplicity, reference numbers of components in this embodiment are the same as those of like components in other embodiments.

Rather than having a member that moves only in the plane parallel to the substrate 18, the movable member 22 in this embodiment moves generally perpendicular to the substrate 18, or in an arcuate manner relative to the substrate 18. Such a design often is referred to as a “cantilevered design.” The stationary contact 28B of this embodiment therefore simply, is generally planar and positioned on the surface of the substrate 18. The contacts 28A and 28B may be comprised of the same materials as discussed above (although schematically shown as appearing to have only one layer—they still may have two layers, which is similar to other embodiments). In a similar manner, this embodiment has other similar components, such as a movable member 22, stationary member 24, and substrate 18. In a manner similar to other embodiments, this embodiment may be contained in a conventional package, such as one of the packages shown in FIGS. 2A or 2B, with or without gettering.

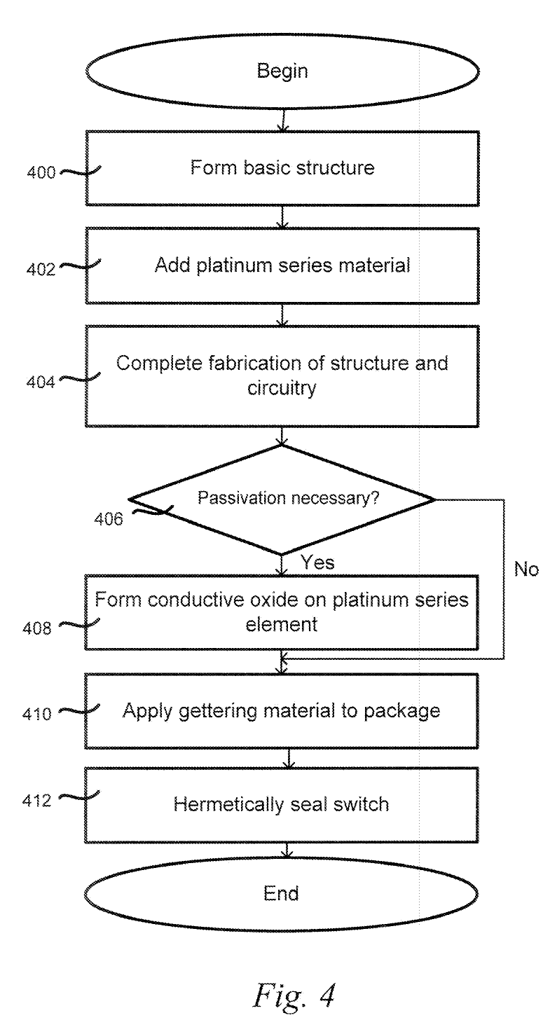

FIG. 4 shows one process of forming a switch in accordance with illustrative embodiments of invention. This switch 16 may be one of those shown in the previous figures, or one having a different configuration. Because it fabricates a MEMS device, the process may use the conventional micromachining technology similar to that commonly used by Analog Devices, Inc., of Norwood, Mass.

It should be noted that for simplicity, the process of FIG. 4 is discussed as forming a single MEMS device. Those skilled in the art should understand, however, that this process can be applied to batch fabrication processes forming a plurality of MEMS devices on a single base wafer. Moreover, the steps of this process are illustrative and do not necessarily disclose each and every step that should or could be used in a MEMS fabrication process. In fact, some of the steps may be performed in a different order. Accordingly, discussion of the process of FIG. 4 is not intended to limit all embodiments of the invention.

The process begins at step 400, which forms the base structure. For example, the process may begin by depositing and etching various layers of materials on a base substrate. The movable member 22 may or may not be formed at this point. For example, the process may fabricate the movable member 22 and expose its end for depositing contact material in a subsequent step. Alternatively, the process may form a recess or specific area on a sacrificial layer for first depositing contact material in a subsequent step, and then depositing material (on the contact material) that forms the movable member 22 in an even later step.

Accordingly, step 402 then deposits the contact materials; namely, the process deposits platinum-series based material on at least the location designated step 400, and on a location that will form the stationary contact 28B. In illustrative embodiments, the process may deposit ruthenium metal through conventional means, such as with a sputtering or plating mechanism. After it is deposited, conventional wet or dry etch processes pattern the deposited material to ensure that the ruthenium is at the correct contact locations. Alternatively, as noted above, rather than deposit ruthenium metal, this step may deposit and pattern a conductive oxide, such as ruthenium dioxide, in a conventional manner to the relevant location.

The process then continues to step 404, which completes fabrication of the structure and circuitry on the switch die. As noted above, this step may employ conventional surface micromachining technologies, such as plating, deposition, patterning, etching, and release operations. For example, this step may deposit sacrificial oxides and conductive layers to form the movable member 22 and other components, and then release the movable member 22 and other suspended components (if any). In illustrative embodiments, the movable member 22 is primarily formed from gold or a gold alloy.

It then is determined at step 406 if the contacts 28A and/or 28B should be passivated (i.e., protected from the environment of the package chamber 36, which, as noted above, could have residual oxygen or other contaminants). If step 402 deposited a platinum-series metal, such as ruthenium, then the contact 28A and/or 28B should be passivated to minimize formation of an insulative surface contamination layer. In that case, the process continues to step 408, which first cleans the contacts 28A and 28B (e.g., removing any oxidization that occurred to that point), and then forms a conductive oxide on the platinum-series element. For example, the process may form ruthenium dioxide on a ruthenium metal contact 28A and/or 28B substantially entirely covering its entire area. In some embodiments, however, the entire area of the ruthenium metal contact 28A and/or 28B is not covered (only a portion of it is covered).

Among other ways, the ruthenium contacts 28A and/or 28B may be exposed to a thermal oxidizing environment at an elevated temperature (e.g., 200 degrees C. or greater). Alternatively, ruthenium dioxide may be directly sputtered on a surface using DC magnetron sputtering. Typical sputtering conditions, for example, may be at temperatures of 300° C., 12 mTorr pressure, with an argon/oxygen mix at 14/45 sccm. This should form a uniform a ruthenium dioxide layer that could be patterned as required by the device application. Etching materials may include O₂/CF₄, O₂Cl₂, or O₂/N₂ plasmas. Exposure of ruthenium metal to an oxygen plasma also should result in the selective formation of a conductive ruthenium dioxide passivation layer over the existing patterned ruthenium based metal.

Step 408 may be entirely skipped, however, if step 406 determines that passivation is not necessary. In either case, the process continues to optional step 410, which applies gettering material to the package or the die. For example, as noted above, this gettering material may control free oxygen (among other things), which, in some instances, can form a native, insulating oxide if exposed to the contacts 28A and/or 28B. As noted above, the impact of oxygen on the contacts 28A and 28B should be substantially mitigated if an area within the chamber 36 having a platinum-series “gettering” metal that is significantly greater than the area of the contacts 28A and 28B. In some embodiments, the gettering metal is the same as the metal used on the contacts 28A and/or 28B. Other embodiments, however, use different metals.

The process then concludes at step 412 by hermetically sealing the switch 16 in ambient oxygen levels that are sufficiently low so as not to saturate the gettering system 38 formed by step 410. One of ordinary skill in the art can determine those levels based on a number of factors.

Accordingly, illustrative embodiments of the invention benefit from the material properties of platinum-series based materials while mitigating the contamination problems that prevented known prior art devices from using such materials. Moreover, various embodiments further protect against possible contamination with a gettering system 38 within the package chamber 36. Among other benefits, these optimizations should improve switch performance and increase switch lifetime.

Although the above discussion discloses various exemplary embodiments of the invention, it should be apparent that those skilled in the art can make various modifications that will achieve some of the advantages of the invention without departing from the true scope of the invention. For example, in some embodiments, only one contact 28A or 28B is formed as discussed above, while the other contact 28B or 28A is formed by conventional means, such as with gold or a gold alloy. In other embodiments, an apparatus may have a plurality of contacts that operate in parallel.

What is claimed is:

1. A MEMS switch comprising:
a first contact; and
a second contact that is movable relative to the first contact,
at least one of the first contact and the second contact being electrically conductive and comprising a platinum-series based material.

2. The MEMS switch as defined by claim 1 wherein the platinum-series based material comprises a platinum-series element.

3. The MEMS switch as defined by claim 1 wherein the platinum-series based material is a platinum-series based passivation.

4. The MEMS switch as defined by claim 1 wherein the at least one of the first and second contacts comprises a platinum-series based element and a conductive passivation.

5. The MEMS switch as defined by claim 4 wherein the platinum-series based element comprises ruthenium and the conductive passivation comprises ruthenium dioxide.

6. The MEMS switch as defined by claim 1 further comprising a package containing at least a portion of the MEMS switch, the package comprising a gettering site.

7. The MEMS switch as defined by claim 6 wherein the package comprises a cap having an interior surface supporting an exposed platinum-series element.

8. The MEMS switch as defined by claim 6 wherein the package hermetically seals the first and second contacts.

9. A MEMS apparatus comprising:
a substrate;
a first contact; and
a movable member having a second contact that moves relative to the substrate, the substrate supporting the movable member,
at least one of the first contact and second contact having a conductive platinum-series based material that provides an electrical connection when contacting the other electrical contact.

10. The MEMS apparatus as defined by claim 9 further comprising an actuator for moving the movable member into contact with the first contact, the actuator comprising one of an electrostatic actuator, electromagnetic actuator, or thermal actuator.

11. The MEMS apparatus as defined by claim 9 wherein the platinum-series based material comprises a platinum-series element.

12. The MEMS apparatus as defined by claim 9 further comprising a first member supporting the first contact, the platinum-series based material being a platinum-series based oxide that directly contacts one of the first member or the movable member.

13. The MEMS apparatus as defined by claim 9 wherein the at least one of the first and second contacts comprises a platinum-series based element and a conductive oxide.

14. The MEMS apparatus as defined by claim 9 further comprising a package containing at least a portion of the MEMS apparatus, the package having an oxygen gettering site.

15. The MEMS apparatus as defined by claim 14 wherein the oxygen gettering site comprises a platinum-series based element.

16. A MEMS switch comprising:
first means for making electrical contact; and
second means for making electrical contact, the second electrical contact means being movable relative to the first electrical contact means,
at least one of the first electrical contact means and the second electrical contact means being electrically conductive and comprising a platinum-series based material.

17. The MEMS switch as defined by claim 16 further comprising means to gettering oxygen within the switch.

18. The MEMS switch as defined by claim 16 wherein the first and second electrical contact means each comprise an electrical contact.

19. The MEMS switch as defined by claim 16 wherein the platinum-series based material comprises a platinum-series based element.

20. The MEMS switch as defined by claim 19 wherein the platinum-series based material further comprises a conductive passivation.
